(19) United States
(12) Patent Application Publication
(10) Pub. No.: US 2019/0019169 A1
(43) Pub. Date: Jan. 17, 2019

(54) METHOD AND SYSTEM FOR IMPROVED TRANSACTION PROCESSING AND ROUTING

(71) Applicant: MASTERCARD INTERNATIONAL INCORPORATED, Purchase, NY (US)

(72) Inventors: Edward Grunde McLaughlin, Newton, PA (US); Sherri Gayle Haymond, Westport, CT (US); Carl D. Jansson, St. Charles, MO (US); Dana J. Lorberg, St. Louis, MO (US); Richard Clark, Webster Groves, MO (US)

(73) Assignee: MASTERCARD INTERNATIONAL INCORPORATED, Purchase, NY (US)

(21) Appl. No.: 16/034,489

(22) Filed: Jul. 13, 2018

Related U.S. Application Data
(60) Provisional application No. 62/533,077, filed on Jul. 16, 2017.

(51) Int. Cl. G06Q 20/08; G06Q 20/40

(52) U.S. Cl. CPC G06Q 20/085; G06Q 2220/00; G06Q 20/401

(57) ABSTRACT

A method for intelligent switching for multiple transaction types includes: storing a plurality of action events, each associated with one of a plurality of data types and including corresponding executable processes; storing each of the executable processes corresponding to each action event; receiving a data message from a third party system; identifying a specific data type of the data message; and executing a specific action event that is associated with the specific data type, wherein executing the specific action event includes executing each of the corresponding executable processes, at least one of the corresponding executable processes includes transmitting the received data message to an authorization system associated with the specific data type, and the plurality of data types includes at least a financial transaction message and an automated clearing house message.

### FIELD

The present disclosure relates to improved transaction processing and routing, specifically the use of cloud-based applications and intelligent switching to enable transaction of multiple types to be processed through a single platform.

### BACKGROUND

Currently payment transactions are routed through different systems based on their type: card-based transactions go through one system, wire transfers and other automated clearing house (ACH) transactions go through a second system, blockchain and other cryptocurrency transactions go through a third system, etc. In addition, many of these systems are typically built to route through dedicated hardware situated throughout the world toward a single or a handful of data centers that perform most, if not all, of the processing for the transactions. Such complicated routing can take a significant amount of time based on the geographic location of the transaction and the involved entities, bottlenecks caused by the physical hardware, and other physical limitations. In addition, the use of physical hardware may make it difficult, time consuming, and expensive to update and improve the processing system.

For merchants and other entities (herein referred to as “participants”) that want to avail themselves of the benefits of using multiple networks (e.g., enabling their customers to pay using any type of network and related currency), they are required to tailor their point of sale systems to be able to operate with each of these networks. For many businesses, particularly small business or owners that are less technology-savvy, this may be exceedingly difficult, if not also very costly to implement. Furthermore, any time one of the transaction processing systems is updated, it may require end updates by the merchant as well, further compounding their difficulties.

Thus, there is a need for a technical improvement to existing payment transaction processing and routing systems to provide intelligent switching to enable transactions of varying types to be submitted through a single communication system yet still be able to be processed by the appropriate processing system. This enables access to different systems that can be computationally simpler, require less dedicated hardware and a simplified user terminal and experience.

### SUMMARY

The present disclosure provides a description of systems and methods for intelligent switching for payment transactions of multiple types. All transactions submitted by participants are fed into a centralized processing server (which may be cloud-based, or have cloned servers throughout the world to reduce processing times and improve reliability). The processing server uses action events that are tied to various executable processes, where each transaction type has its own action event(s) associated therewith. When a transaction is received, its type is analyzed and the corresponding action event(s) identified, where the tied executable processes are then executed to perform any necessary processing and culminating in the intelligent routing of the transaction message to the appropriate processing system. The result is that a participant can submit all of their transactions to the server, where they are routed to the proper processor. At the same time, the use of action events and executable processes means that changes to the configuration of the server (e.g., rules or routing updates by the transaction processors) can be performed with minimal, if any, modification to the server platform, as executable processes can be easily adjusted, added, or removed without affecting the underlying action events, and thus minimizing interruption of service or need to change overall processing of received transaction messages. The result is a new type of routing system that is both more efficient and more effective for all entities involved.

A method for intelligent switching for multiple transaction types includes: storing, in a memory of a processing server, a plurality of action events, wherein each action event is associated with one of a plurality of data types and includes one or more corresponding executable processes; storing, in the memory of the processing server, each of the one or more executable processes corresponding to each of the plurality of action events; receiving, by a receiver of the processing server, a data message from a third party system; identifying, by a processing device of the processing server, a specific data type of the data message; and executing, by the processing device of the processing server, a specific action event that is associated with the specific data type, wherein executing the specific action event includes executing each of the one or more corresponding executable processes, at least one of the one or more corresponding executable processes includes transmitting, by a transmitter of the processing server, the received data message to an authorization system associated with the specific data type, and the plurality of data types includes at least a financial transaction message and an automated clearing house message.

A system for intelligent switching for multiple transaction types includes: a memory of a processing server configured to store a plurality of action events, wherein each action event is associated with one of a plurality of data types and includes one or more corresponding executable processes, and each of the one or more executable processes corresponding to each of the plurality of action events; a receiver of the processing server configured to receive a data message from a third party system; a processing device of the processing server configured to identify a specific data type of the data message, and execute a specific action event that is associated with the specific data type, wherein executing the specific action event includes executing each of the one or more corresponding executable processes, at least one of the one or more corresponding executable processes includes transmitting, by a transmitter of the processing server, the received data message to an authorization system associated with the specific data type, and the plurality of data types includes at least a financial transaction message and an automated clearing house message.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for intelligent switching of payment transactions in accordance with exemplary embodiments.

FIG. 2 is a block diagram illustrating the processing server of the system of FIG. 1 for intelligent switching of payment transactions in accordance with exemplary embodiments.

FIG. 3 is a flow diagram illustrating a system topography of the processing server and associated intelligent switching network of FIG. 1 in accordance with exemplary embodiments.

FIG. 4 is a flow chart illustrating a process for the intelligent routing of a transaction message using action events and executable processes as performed by the processing server of FIG. 2 in accordance with exemplary embodiments.

FIG. 5 is a flow chart illustrating an exemplary method for intelligent switching for multiple transaction types in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Intelligent Switching of Transaction Messages

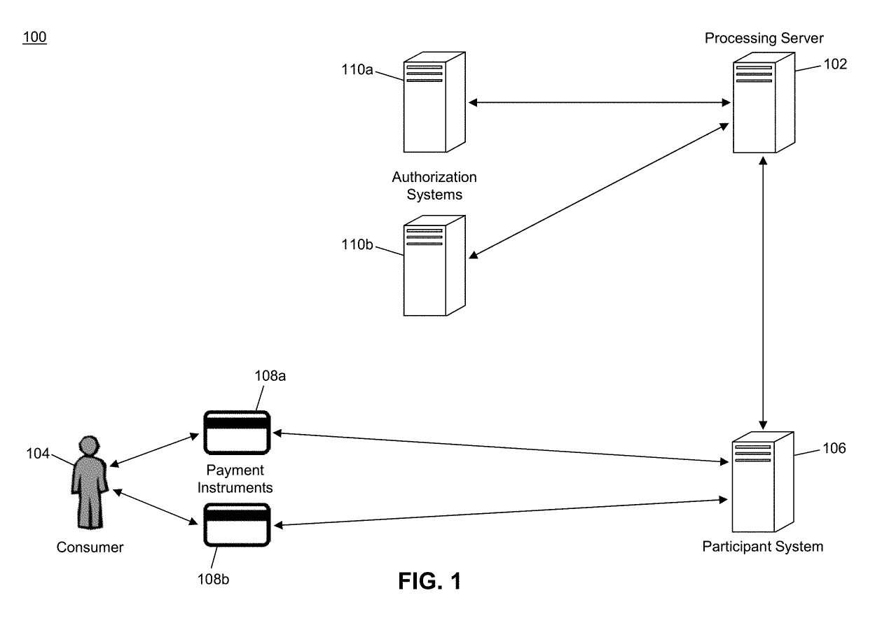

FIG. 1 illustrates a system 100 for the intelligent switching of transaction messages of varying transaction types performed via the use of action events and executable processes.

The system 100 may include a processing server 102. The processing server 102, discussed in more detail below, may be configured to perform intelligent switching for transaction messages received for electronic payment transactions of varying types, where the transaction messages are routed to an authorization system corresponding to the type for authorization thereby. In the system, 100, two entities may be involved in a payment transaction where one entity makes a payment to the other entity, such as a consumer 104 making a payment to a participant system 106 as illustrated in FIG. 1 for the purchase of goods or services. Persons having ordinary skill in the art will understand that the methods discussed herein are also applicable for person-to-person or business-to-business transactions and for transactions that may be submitted by either entity, such as by the consumer 104 or the participant system 106.

The consumer 104 may have multiple payment instruments 108 issued thereto, illustrated in FIG. 1 as payment instrument 108a and payment instrument 108b. Each of the payment instruments 108 may be associated with a different type of transaction such that the transaction, when processed as discussed in more detail below, is processed by a different authorization system 110. For instance, as illustrated in FIG. 1, the system 100 may include an authorization system 110a configured to process payment transactions funded via the payment instrument 108a in addition to an authorization system 110b configured to process payment transactions funded via the payment instrument 110b. In an example, the payment instrument 108a may be a credit card, where the authorization system 110a may be a credit card processing network, such as one operated by Mastercard®, whereas the payment instrument 108b may be account details for a transaction account where the transaction is a wire transfer where the authorization system 110b is the Automated Clearing House (ACH). In another example, a payment instrument 108 may be a blockchain wallet, where the authorization system 110 is a node in a blockchain network configured to process blockchain transactions.

The consumer 104 may present a payment instrument 108 to the participant system 106 to convey payment details for funding a payment transaction between the consumer 104 and the other participant. The participant system 106 may receive the payment details and may submit the payment details along with other transaction data for processing. In conventional systems, the participant system 106 would submit the payment details and transaction data to an authorization system 110, either directly or via an intermediate entity associated therewith, such as an acquiring financial institution or gateway processor, where the data is transmitted from there directly to the authorization system 110 using infrastructure associated therewith. In these conventional systems, the participant system 106 must be configured to submit transaction details to each authorization system 110 independently in order to accept the associated payment instrument 108 as payment.

In the system 100, the participant system 106 may submit every transaction directly to the processing server 102 using a suitable communication network and method. The processing server 102 may be configured to receive the transaction data including the payment credentials read from the supplied payment instrument 108. The processing server 102 may receive a data message from the participant system 106 (e.g., or an intermediate entity, as applicable) that includes this transaction data. The data message may also include data that is used by the processing server 102 to identify a type of transaction indicated by the data message. For instance, the data message may include a flag or data value where the value thereof is associated with a particular transaction type. For example, an integer value may be associated with each transaction type that the processing server 102 is configured to route (e.g., a ‘1’ for credit card transactions, ‘2’ for wire transfers, ‘3’ for blockchain transactions, etc.). In another example, the processing server 102 may identify the type of transaction based on the payment details included in the transaction data, such as where a credit card transaction is indicated by a primary account number, a wire transfer indicated by an account number and routing number, and a blockchain transaction indicated by a blockchain address and digital signature. Additional flags or types of payment details may also be utilized to accommodate additional transaction types as will be apparent to persons having skill in the relevant art.

The processing server 102 may be configured to store a plurality of action events therein. Each action event may be an event that occurs as detected by the processing server 102 that must be acted upon by the processing server 102. Each action event may be associated with one or more executable processes, which may be processes that are to be performed by the processing server 102 as a result of the detected action. For example, the processing server 102 may include an action event for each transaction type for which it is configured to intelligently switch. For instance, there may be an action event for credit card transactions, an action event for check transactions, an action event for debit transactions, an action event for wire transfers, an action event for blockchain transactions, or separate action events for each type of blockchain transaction if multiple cryptographic currencies may be processable through the intelligent switching of the processing server.

The executable processes may be modifiable, such that an executable process may be modified without affecting any associated action event. As a result, an authorization system 110 may be able to change routing information or rules associated with the processing of a transaction without interrupting the intelligent switching performed by the processing server 102, resulting in easier adoption and updating of the system. For example, an authorization system 110a may change a communication address for routing of its transactions without affecting several other executable processes that need to be performed by the processing server 102 for those types of transactions (e.g., fraud scoring, tokenization, application of transaction controls, etc.). This may also enable a single executable process to be associated with multiple action events where a change to that process may be applicable to all of the action events, without the need to change any of the action events themselves. For example, the processing server 102 may improve its fraud scoring without having to make any changes to the action events for each transaction type, resulting in easier updating to the system. Similarly, the executable processes associated with an action event may be changed, such that processes may be added to or removed from an action event without interrupting any other executable processes.

In the system 100, the processing server 102 may thus identify an action event that is applicable to the data message submitted by the participant system 106 based on the transaction type as identified. The processing server 102 may then execute the executable processes that are associated with that action event. In some cases, the executable processes may have a priority order or other hierarchy associated therewith that may be followed by the processing server 102 in the execution thereof. For each of the action events, at least one of the executable processes may involve the routing of the data message to the appropriate authorization system 110 for that transaction type. In some instances, the processing server 102 may first (e.g., according to an executable process for that action event) reformat the data message or create a secondary data message that is formatted according to standards set by the authorization system 110. For example, data messages for credit card transactions may be formatted as transaction messages that are compliant with the International Organization of Standardization's ISO 8583 or ISO 20022 standards. The message may then be routed to the authorization system 110 using the appropriate communication network and method. For instance, each authorization system 110 may have its own type of infrastructure for use in routing messages thereto. For example, credit card processing networks may require transaction messages to be transmitted via payment rails associated therewith. The authorization system 110 may then process the transaction using its traditional methods and systems where, in some cases, a response message may be routed back to the participant system 106 via the processing server 102.

In some embodiments, multiple authorization systems 110 may exist for each transaction type. In such cases, the processing server 102 may select an authorization system 110 for routing of a data message based on the geographic location of the payment transaction (e.g., as indicated in the transaction data or otherwise identifiable by the processing server 102) or other criteria. In some cases, the selection of a specific authorization system 110 for a transaction may be indicated by the result of an executable process executed as part of that transaction type's action event. For example, an executable process may determine the geographic location of a transaction or the processing server 102 and select the closest (e.g., geographically or via network communication) authorization system 110 for routing thereto. In some embodiments, a processing server 102 may operate as an authorization system 110 for one or more transaction types. In such embodiments, the results of the executable processes for an action event may be a routing of the processing server 102 to itself (e.g., from a module or application program therein for intelligent switching to another module or application program therein for transaction processing). The module that receives the data message for processing may process the transaction through another action event associated therewith, where the processing may be performed through the execution of associated executable processes.

In some embodiments, the processing server 102 may be a part of an international network of processing servers. In such embodiments, each of the processing servers 102 may be a cloned system or be otherwise configured to perform the same functions as each other processing server 102. In some cases, each processing server 102 may be configured to communicate with one another, such as to assist in the routing of messages, updating of executable processes or action events, performing of value added services, etc. For example, a processing server 102 located in a first country may request a fraud scoring to be performed by a processing server 102 in a different country using its local fraud rules due to the use of a transaction account issued in that different country, but in a transaction that takes place in the first country.

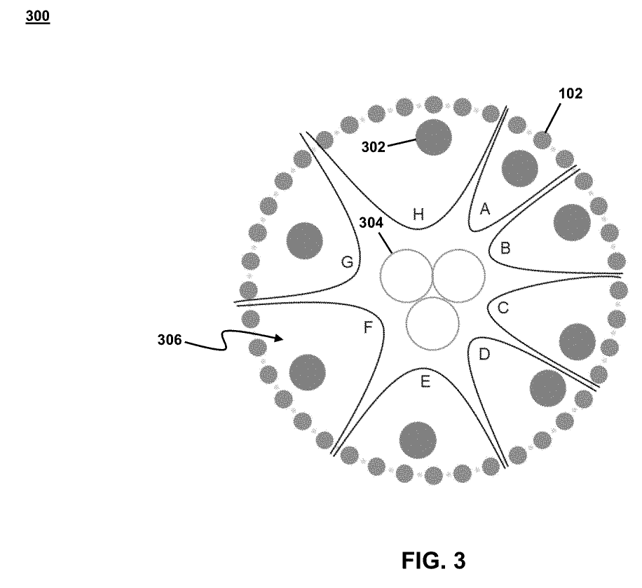

In some such embodiments, each of the processing servers 102 may be associated with a geographical region. In these embodiments, the processing servers 102 may be configured to communicate directly only to other processing servers 102 in that geographic region. In such cases, each geographic region may also include a hub server, also referred to as a region hub or zone hub. The processing servers 102 may be configured to communicate with the hub server in its geographic region, where each of the hub servers may be configured to communicate with other hub servers. In these cases, if a processing server 102 needs to communicate with a processing server in another region (e.g., for a local fraud score from a different country), the processing server 102 may request the score through its local hub server, which may contact the hub server in the desired region, which may contact a processing server in its region to perform the fraud score. In some embodiments, there may also be a number of centralized data centers that act as hubs for the region hub servers, to facilitate communications between the hub servers, push updates to the hub servers, assist in the routing of network traffic, etc. An illustrative look at such a topography is provided in FIG. 3, discussed in more detail below. In some cases, executable processes or action events may have a level associated therewith (e.g., local, regional, global) where such events or processes may only be performed by a hub or server at that level. For example, cross-border transactions may be processed by regional hubs or global hubs and not local processing servers 102.

In some embodiments, each processing server 102 may be configured to utilized cloud-based computing for the performing of functions discussed herein. For example, the action events and executable processes may be performed using cloud-based computing techniques, where the executable processes are executed by any applicable processing server 102 connected in the cloud (e.g., which may consist of all processing servers 102 in a geographic region, the hub server in a geographic region, all processing servers 102 regardless of region, etc.). In some cases, each of the application programs or modules included in a processing server 102 may be stored in and/or executed using cloud-based computing. For instance, each processing server 102 may have application programs executable thereby through a cloud to perform the traditional functions of transaction processors or authorization systems 110. For example, functions traditionally performed by an integrated processor for a credit card processing network may be implemented in a processing server 102 through a cloud architecture. In such embodiments, processing servers 102 may not need a physical presence for any participant system 106, where data messages may be submitted to the cloud of processing servers 102 by participant systems through applicable communication networks and methods.

The methods and systems discussed herein provide for intelligent routing for electronic payment transactions. The processing server 102, using action events and executable processes, can facilitate the routing of transaction messages for transactions of any appropriate type for a participant system 106. This results in a participant system 106 being able to accept any form of payment from a consumer 104 using a single connection to the processing server 102, without having to modify itself for communication with various types of authorization systems 110. In addition, modifications to processes or communication by authorization systems 110 will leave the participant system 106 unaffected, as it needs only to be able to communicate with the processing server 102, further increasing the convenience and adaptability for participant systems 106. The implementation of intelligent switching using action events and executable processes provides similar benefits, as discussed above, where processes can be changed for multiple action events, or where the processes that are applied to an action event, can be easily changed without affecting the overall action. This results in faster and easier modification for processing of transactions of any type, including significantly easier modification to processes that must be performed for all or multiple transaction types. For instance, value-added services (e.g., fraud scoring, transaction controls, etc.) performed by the processing server 102 can be changed or adjusted without affecting the overall action events for transactions, leaving the authorization systems 110 and communications therewith untouched.

### Processing Server

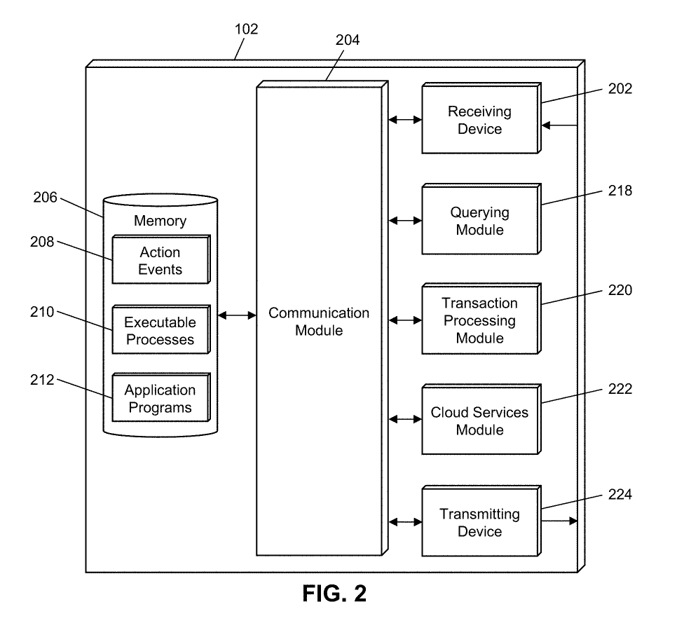

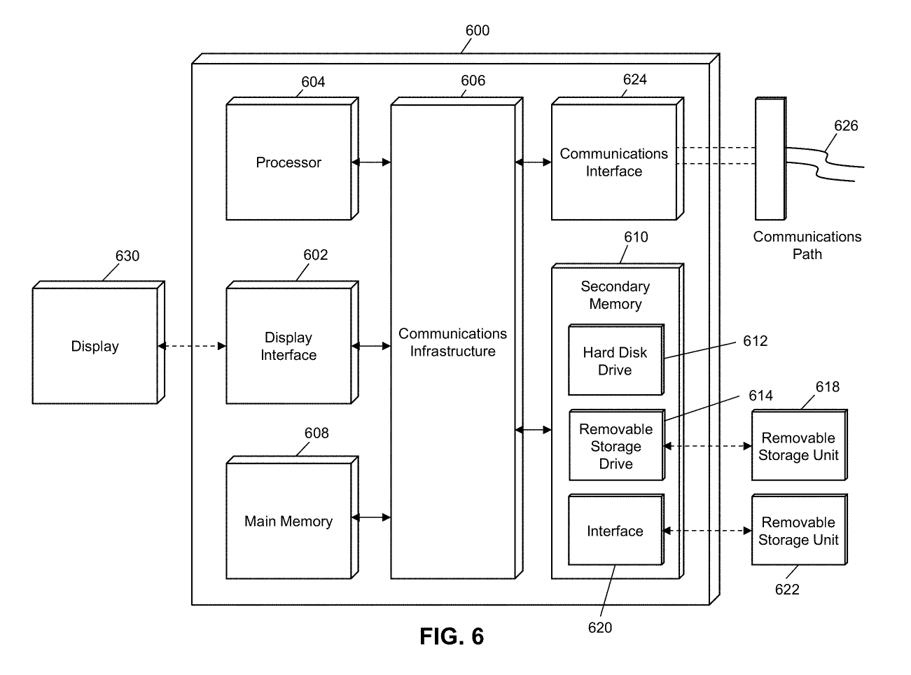

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from participant systems 106, authorization systems 110, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by participant systems 106 that may be superimposed or otherwise encoded with data messages for intelligent switching. As discussed above, each data message may include transaction data, which may include data used by the processing server 102 in identifying a transaction type for the data message. The receiving device 202 may also be configured to receive data signals electronically transmitted by authorization systems 110, which may be superimposed or otherwise encoded with responses for data messages, updates to executable processes, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, transaction processing module 220, cloud services module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a memory 206. The memory 206 may be configured to store data for use by the processing server 102 in performing the functions discussed herein. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein. The memory 206 may be configured to store, for example, data standards, message formatting rules, fraud scoring rules, transaction controls, currency exchange rate data and algorithms, etc.

The memory 210 may include a plurality of action events 208. Each action event may be associated with a transaction type and include one or more executable processes 210 associated therewith. The memory 210 may also include these executable processes 210. Each executable process 210 may be one or more actions that are to be executed by the processing server 102 (e.g., a processing device or module included therein). Example executable processes 210 include fraud scoring, application of transaction controls, tokenization or de-tokenization of data, calculation of currencies based on exchange rates, validation of digital signatures, application of offers or discounts, redemption of reward points, etc. Each action event 208 may include at least one executable process 210 for the routing of a data message to an appropriate authorization system 110 configured to process transactions of the respective type.

The memory 210 may also include a plurality of application programs 212. Each of the application programs 212 may include program code for execution by a processing device of the processing server 102 for running the application program 212, which may be configured to perform functions discussed herein. For instance, one application program 212 may be used for generating and formatting data messages based on applicable standards, while a second application program 212 may be used for scoring attempted payment transactions for fraud. In some embodiments, one or more application programs 212 may be implemented through cloud computing techniques, such that the data stored in the memory 206 may only be the data necessary for use by the processing server 102 in having the application program 212 executed through the cloud architecture.

The processing server 102 may include a querying module 218. The querying module 218 may be configured to execute queries on databases to identify information. The querying module 218 may receive one or more data values or query strings, and may execute a query string based thereon on an indicated database, such as the memory 206, to identify information stored therein. The querying module 218 may then output the identified information to an appropriate engine or module of the processing server 102 as necessary. The querying module 218 may, for example, execute a first query on the memory 206 to identify an action event 208 for a received data message based on the type of transaction indicated thereby, and then execute one or more additional queries to identify the executable processes 210 to be executed by that action event 208 based on data included therein.

The processing server 102 may also include a transaction processing module 220. The transaction processing module 220 may be configured to perform functions for the processing server 102 related to the processing and/or routing of electronic payment transactions as discussed herein. Such functions may include, for example, the routing of authorization requests and authorization responses to/from authorization systems 110, the generation of formatted data messages, the swapping of an account number to/from a PAN in an authorization request or authorization response, the calculation of a flat currency amount or blockchain currency amount via an exchange rate, etc. In some cases, the transaction processing module 220 may be implemented through one or more application programs 212, which may be further implemented using cloud-based computing techniques. In cases where the processing server 102 may serve as an authorization system 110 for one or more transaction types, the transaction processing module 220 may be configured to process transactions of the respective types accordingly using traditional methods and systems.

The processing server 102 may also include a cloud services module 222. The cloud services module 222 may be configured to perform the functions of the processing server 102 related to implementation of one or more application programs 212 or services using cloud-computing techniques. For instance, the cloud services module 222 may maintain or facilitate communications with other processing servers 102 for cloud implementation.

The processing server 102 may also include a transmitting device 224. The transmitting device 224 may be configured to transmit data over one or more networks via one or more network protocols. In some instances, the transmitting device 224 may be configured to transmit data to participant systems 106, authorization systems 110, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to authorization systems 110 that are superimposed or otherwise encoded with data messages as part of the intelligent routing thereof. In some cases, such data signals may also or alternatively be superimposed or otherwise encoded with information regarding executable processes 210, such as statuses of executable processes, changes thereto, confirmation of updates thereto, etc. The transmitting device 224 may also be configured to electronically transmit data signals to participant systems 106, which may be superimposed or otherwise encoded with data messages as part of the processing of payment transactions, such as response messages provided by authorization systems 110 for routing to the participant systems 106 for payment transactions.

### Example System Topography

FIG. 3 illustrates an example topography of the processing server 102 in the system 100 as part of a larger system 300 used for the intelligent routing of payment transactions across transactions of multiple types. As discussed above and illustrated in FIG. 3, the system 300 may include a plurality of processing servers 102. Each processing server 102 may be configured to perform the functions discussed herein. Each of the processing servers 102 may be located in a region 306. In some cases, the regions 306 may be geographic regions and created based on geographical delineations, such as country borders, continents, etc. In other cases, the regions 306 may be based on network communication capabilities, such as based on transmission lengths and times. Any suitable type of demarcation for the regions 306 may be used. In some cases, each processing server 102 in a region 306 may only be able to communicate with other processing servers 102 in the same region 306.

Each region 306 may also include at least one region hub 302. A region hub 302 may be a server configured to facilitate communications between processing servers 102 in different regions 306, such as by communicating directly with other region hubs 302, which may in turn communicate with the processing servers 102 in its own region. In some cases, a region hub 302 may also be configured to perform executable processes 210 that may bridge across multiple regions 306, such as for cross-border transactions, analytics on a regional scale, etc.

The system 300 may also include one or more global hubs 304. Each global hub 304 may be configured to facilitate communications between region hubs 302 if necessary, or may be able to assist in the communications between processing servers 102 across regions, particularly in instances where three or more regions may be involved, such as cross-border transactions where fraud rules in additional countries may be involved. Global hubs 304 may also be configured to perform executable processes 210 that may be global in scale, such as for high level analytics, updating of region hubs 302, data warehousing, management of master parameter systems, etc.

### Process for Intelligent Switching of Data Messages

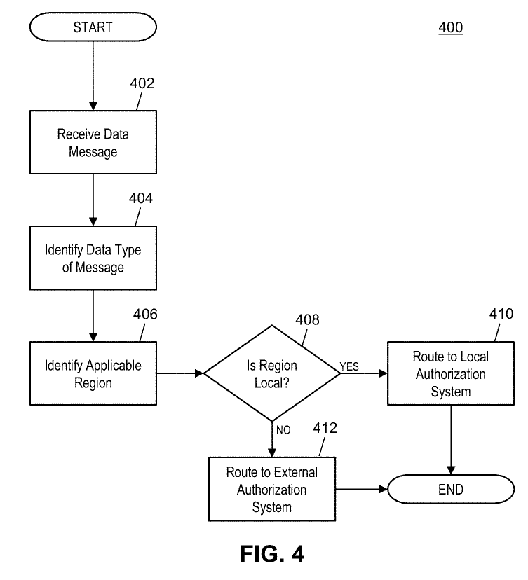

FIG. 4 illustrates a process 400 for the intelligent switching of data messages for transactions of multiple types through the use of action events and executable processes by the processing server 102 in the system 100.

In step 402, the receiving device 202 of the processing server 102 may receive data message electronically transmitted by the participant system 106 using a suitable communication network and method. The data message may include data for an electronic payment transaction including transactional data (e.g., transaction amount, recipient account information, blockchain addresses, routing numbers, currency types, etc., as applicable) and payment details associated with a payment instrument 108 used by a consumer 104 to fund the payment transaction. In step 404, the processing server 102 may identify a data type for the data message. In some cases, the data type may be directly indicated in the data message, such as through a flag or data value. In other cases, the data type may be inferred by data included in the data message, such as through an assessment of the payment details to determine the type of payment instrument 108 used.

In step 406, the processing server 102 may identify an applicable region for the data message. The applicable region may be identified through the execution of one or more executable processes 210 for the transaction type, as indicated in the action event 208 for the transaction type. The querying module 218 of the processing server 102 may execute a query on the memory 206 to identify the action event 208 for the transaction type as identified, and subsequently execute a query on the memory 206 to identify the executable processes 210 for the action event 208 as indicated therein. The processing server 102 may then execute the executable processes 210 to identify the applicable region for the data message.

In step 408, the processing server 102 may identify if the applicable region for the data message is the local region 306 for the processing server 102. If it is, then, in step 410, the transmitting device 224 may route the data message (e.g., reformatted if necessary through an applicable executable process 210) to an authorization system 110 in the local region 306 as indicated by an executable process 210 associated with the action event 208. The authorization system 110 may then process the transaction accordingly. If, in step 408, the processing server 102 determines that the data message is to be processed in a different region 306, then, in step 412, the transmitting device 224 of the processing server 102 may route the data message to an authorization system 110 in the applicable region 306. In some cases, the data message may be first transmitted to a processing server 102 in that region 306, either directly or through the region hub 302 for the local region 306. The processing server 102 in the applicable region may then forward the data message on to the appropriate authorization system 110 in that region, as indicated by the associated executable process 210, for processing by the authorization system 110.

### Exemplary Method for Intelligent Switching for Multiple Transaction Types

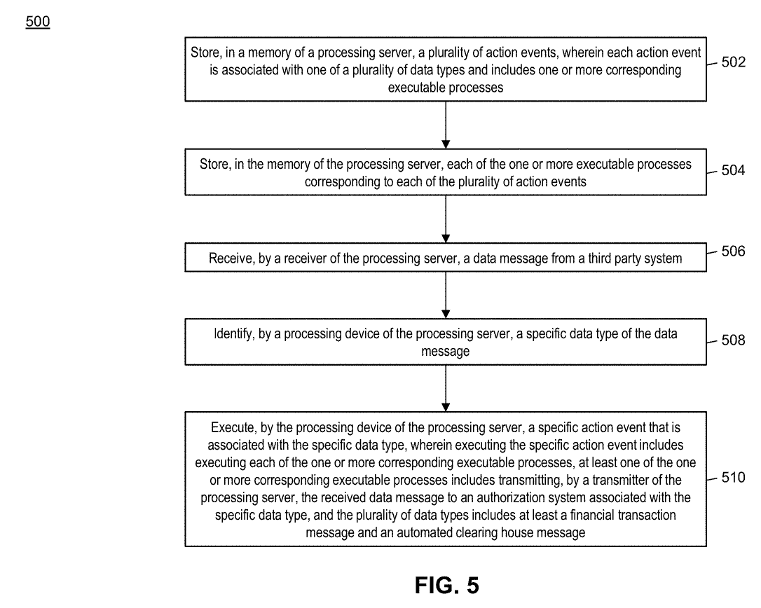

FIG. 5 illustrates a method 500 for the intelligent switching of data messages for multiple transaction types to appropriate authorization systems using action events and executable processes for accurate switching with minimal intrusion to participant and authorization systems.

In step 502, a plurality of action events (e.g., action events 208) may be stored in a memory (e.g., the memory 206) of a processing server (e.g., the processing server 102), wherein each action event is associated with one of a plurality of data types and includes one or more corresponding executable processes (e.g., executable processes 210). In step 504, each of the one or more executable processes corresponding to each of the plurality of action events may be stored in the memory of the processing server. In step 506, a data message may be received by a receiver (e.g., the receiving device 202) of the processing server from a third party system (e.g., the participant system 106).

In step 508, a specific data type of the data message may be identified by a processing device of the processing server. In step 510, a specific action event that is associated with the specific data type may be executed by the processing device of the processing server, wherein executing the specific action event includes executing each of the one or more corresponding executable processes, at least one of the one or more corresponding executable processes includes transmitting, by a transmitter (e.g., the transmitting device 224) of the processing server, the received data message to an authorization system (e.g., authorization system 110) associated with the specific data type, and the plurality of data types includes at least a financial transaction message and an automated clearing house message.

In one embodiment, the plurality of data types may further include a blockchain message. In some embodiments, the specific data type may be the financial transaction message, and the received data message may be formatted according to an ISO 8583 or ISO 20022 standard. In one embodiment, the authorization system may be a module included in the processing server.

In some embodiments, the received data message may be transmitted to the authorization system using infrastructure associated with the specific data type. In a further embodiment, the specific data type may be the financial transaction message, and the infrastructure is payment rails may be associated with a payment network. In one embodiment, each specific data type may be associated with a plurality of authorization systems, and each of the plurality of authorization systems may be assigned to a specific geographic region. In a further embodiment, the data message may include region data, and the received data message may be transmitted to an authorization system assigned to a specific geographic region corresponding to the region data.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 4 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for intelligent switching for multiple transaction types. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for intelligent switching for multiple transaction types, comprising:
storing, in a memory of a processing server, a plurality of action events, wherein each action event is associated with one of a plurality of data types and includes one or more corresponding executable processes;
storing, in the memory of the processing server, each of the one or more executable processes corresponding to each of the plurality of action events;
receiving, by a receiver of the processing server, a data message from a third party system;
identifying, by a processing device of the processing server, a specific data type of the data message; and
executing, by the processing device of the processing server, a specific action event that is associated with the specific data type, wherein
executing the specific action event includes executing each of the one or more corresponding executable processes,
at least one of the one or more corresponding executable processes includes transmitting, by a transmitter of the processing server, the received data message to an authorization system associated with the specific data type, and
the plurality of data types includes at least a financial transaction message and an automated clearing house message.

2. The method of claim 1, wherein the plurality of data types further includes a blockchain message.

3. The method of claim 1, wherein
the specific data type is the financial transaction message, and
the received data message is formatted according to an ISO 8583 or ISO 20022 standard.

4. The method of claim 1, wherein the authorization system is a module included in the processing server.

5. The method of claim 1, wherein the received data message is transmitted to the authorization system using infrastructure associated with the specific data type.

6. The method of claim 5, wherein
the specific data type is the financial transaction message, and
the infrastructure is payment rails associated with a payment network.

7. The method of claim 1, wherein
each specific data type is associated with a plurality of authorization systems, and
each of the plurality of authorization systems is assigned to a specific geographic region.

8. The method of claim 7, wherein
the data message includes region data, and
the received data message is transmitted to an authorization system assigned to a specific geographic region corresponding to the region data.

9. A system for intelligent switching for multiple transaction types, comprising:
a memory of a processing server configured to store
a plurality of action events, wherein each action event is associated with one of a plurality of data types and includes one or more corresponding executable processes, and
each of the one or more executable processes corresponding to each of the plurality of action events;
a receiver of the processing server configured to receive a data message from a third party system;
a processing device of the processing server configured to
identify a specific data type of the data message, and
execute a specific action event that is associated with the specific data type, wherein
executing the specific action event includes executing each of the one or more corresponding executable processes,
at least one of the one or more corresponding executable processes includes transmitting, by a transmitter of the processing server, the received data message to an authorization system associated with the specific data type, and
the plurality of data types includes at least a financial transaction message and an automated clearing house message.

10. The system of claim 9, wherein the plurality of data types further includes a blockchain message.

11. The system of claim 9, wherein
the specific data type is the financial transaction message, and
the received data message is formatted according to an ISO 8583 or ISO 20022 standard.

12. The system of claim 9, wherein the authorization system is a module included in the processing server.

13. The system of claim 9, wherein the received data message is transmitted to the authorization system using infrastructure associated with the specific data type.

14. The system of claim 13, wherein
the specific data type is the financial transaction message, and
the infrastructure is payment rails associated with a payment network.

15. The system of claim 9, wherein
each specific data type is associated with a plurality of authorization systems, and
each of the plurality of authorization systems is assigned to a specific geographic region.

16. The system of claim 15, wherein
the data message includes region data, and
the received data message is transmitted to an authorization system assigned to a specific geographic region corresponding to the region data.
